(19) United States
(12) Patent Application Publication
(10) Pub. No.: US 2024/0088413 A1
(43) Pub. Date: Mar. 14, 2024

(54) FUEL CELL SYSTEM

(71) Applicant: TOYOTA JIDOSHA KABUSHIKI KAISHA, Toyota-shi (JP)

(72) Inventor: Hiroyuki SUGANUMA, Aichi-gun (JP)

(73) Assignee: TOYOTA JIDOSHA KABUSHIKI KAISHA, Toyota-shi (JP)

(21) Appl. No.: 18/346,510

(22) Filed: Jul. 3, 2023

(30) Foreign Application Priority Data
Sep. 8, 2022 (JP) 2022-142804

(51) Int. Cl. H01M 8/0438; G05D 16/20; H01M 8/04089; H01M 8/04746

(52) U.S. Cl. CPC H01M 8/04388; G05D 16/2022; G05D 16/204; H01M 8/04089; H01M 8/04753; H01M 2250/20

(57) ABSTRACT

A fuel cell system includes, in the fuel gas system, a first fuel supplier of an external valve opening type, an inner valve opening type second fuel supplier, and a fuel gas supply pressure sensor, and when the fuel gas supply pressure is excessive, the fuel cell is operated by the first fuel supplier, and when the fuel gas supply pressure is normal, the fuel cell is operated by using the first fuel supplier and the second fuel supplier in combination.

### CROSS-REFERENCE TO RELATED APPLICATION

This application claims priority to Japanese Patent Application No. 2022-142804 filed on Sep. 8, 2022, incorporated herein by reference in its entirety.

### BACKGROUND

### 1. Technical Field

The present disclosure relates to a fuel cell system.

### 2. Description of Related Art

Various studies have been made on fuel cells (FC). For example, Japanese Unexamined Patent Application Publication No. 2020-087520 (JP 2020-087520 A) discloses a FC system that includes a ON/OFF controlled injector (INJ) and a linear solenoid valve (LSV) of which opening degree can be controlled, and that executes control while a fuel supplier to be used is switched in accordance a FC load and the like.

### SUMMARY

When the fuel supplier is provided with a solenoid for a case where a fuel gas supply pressure is excessively high as a solenoid that is a component of an internal valve open type fuel supplier such as an injector, the size of the fuel supplier increases.

The present disclosure has been made in view of the above circumstances, and it is a main object of the present disclosure to provide a fuel cell system capable of suppressing an increase in size of a solenoid by suppressing an inner valve opening type fuel supplier from being opened when a fuel gas supply pressure is excessively high.

In one aspect of the present disclosure, a fuel cell system is provided. The fuel cell system includes a first fuel supplier of an external valve opening type, a second fuel supplier of an internal valve opening type, and a fuel gas supply pressure sensor in a fuel gas system. When a fuel gas supply pressure is excessively high, the first fuel supplier operates a fuel cell, and when the fuel gas supply pressure is normal, the fuel cell is operated in combination of the first fuel supplier and the second fuel supplier.

In the fuel cell system according to the above aspect of the present disclosure, the first fuel supplier may be a linear solenoid valve, and the second fuel supplier may be an injector.

The fuel cell system according to the above aspect of the present disclosure may further include a control unit. The control unit may determine whether the fuel gas supply pressure measured by the fuel gas supply pressure sensor exceeds a predetermined threshold value. When the fuel gas supply pressure measured by the fuel gas supply pressure sensor exceeds the predetermined threshold value, the control unit may determine that the fuel gas supply pressure is excessively high, and operate the fuel cell by the first fuel supplier. When the fuel gas supply pressure measured by the fuel gas supply pressure sensor is equal to or less than the predetermined threshold value, the control unit may determine that the fuel gas supply pressure is normal, and operate the fuel cell in combination of the first fuel supplier and the second fuel supplier.

The present disclosure can provide a fuel cell system capable of suppressing an increase in size of a solenoid.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic block diagram of a fuel cell system according to an embodiment of the present disclosure; and

FIG. 2 is a flowchart illustrating an example of control of the fuel cell system of the present disclosure.

### DETAILED DESCRIPTION OF EMBODIMENTS

Embodiments according to the present disclosure will be described below. It should be noted that matters other than those specifically mentioned in the present specification and necessary for the implementation of the present disclosure (for example, a general configuration and a manufacturing process of a fuel cell system that does not characterize the present disclosure) can be understood as design matters of a person skilled in the art based on the prior art in the field. The present disclosure can be implemented based on the content disclosed in this specification and common general technical knowledge in the field. In addition, the dimensional relationships (length, width, thickness, etc.) in the drawings do not reflect the actual dimensional relationships. In the present specification, “to” indicating a numerical range is used in a sense including numerical values described before and after the numerical range as a lower limit value and an upper limit value. Any combination of the upper and lower limits in the numerical range can be adopted.

In the present disclosure, a fuel gas system includes a first fuel supplier of an external valve opening type, a second fuel supplier of an internal valve opening type, and a fuel gas supply pressure sensor. When the fuel gas supply pressure is excessively high, the first fuel supplier operates the fuel cell. A fuel cell system is provided in which the fuel cell is operated in combination with the first fuel supplier and the second fuel supplier during a fuel gas supply pressure normal state.

In the prior art, an injector capable of opening even at a fuel gas supply pressure exceeding the normal pressure (relief pressure on the primary side of the injector) is required, and if the injector is provided with a solenoid capable of opening even at a high primary pressure as a solenoid as a component of the injector, the physique of the injector increases. During long-term leaving of the fuel cell system, the primary pressure may become excessive due to the fuel gas passing through the pressure reducing valve (regulator), and when the primary pressure becomes equal to or higher than the predetermined value, the relief valve is opened to reduce the pressure, but since the relief releases the fuel gas to the atmosphere only when the primary pressure becomes equal to or higher than the predetermined value, in the prior art, there is no mechanism for safely releasing and regulating the excessive primary pressure. Therefore, the fuel cell system of the present disclosure is configured to include an external valve-open type first fuel supplier (for example, a linear solenoid valve or the like) and an internal valve-open type second fuel supplier (for example, an injector or the like) as a fuel supplier, and when the fuel gas supply pressure is excessively large (a case where the primary pressure exceeds the normal pressure through permeation from the pressure reducing valve during long-term standing), the fuel cell system is started by the external valve-open type first fuel supplier to optimize the fuel gas supply pressure and then shifts to the normal control.

In the present disclosure, fuel gas and oxidant gas are collectively referred to as reactant gas. The reaction gas supplied to the anode is a fuel gas (anode gas), and the reaction gas supplied to the cathode is an oxidant gas (cathode gas). The fuel gas is a gas containing primarily hydrogen and may be hydrogen. The oxidizing gas is a gas containing oxygen, and may be air or the like.

The fuel cell system of the present disclosure may be mounted on a moving body such as a vehicle and used. The vehicles may be fuel cell electric vehicle, etc. Examples of the moving body other than the vehicle include a railway, a ship, and an aircraft. Further, the fuel cell system of the present disclosure may be mounted on a moving body such as a vehicle capable of traveling even with electric power of a secondary battery. The vehicle may comprise the fuel cell system of the present disclosure. The moving body may include a drive unit such as a motor, an inverter, and a hybrid control system. The hybrid control system may be capable of driving a moving body by using both the output of the fuel cell and the electric power of the secondary battery.

The fuel cell system of the present disclosure includes, in the fuel gas system, a first fuel supplier of an external valve opening type, a second fuel supplier of an internal valve opening type, and a fuel gas supply pressure sensor, and may optionally include a relief valve, an ejector, a gas-liquid separator, an exhaust drain valve, an anode gas passage, an anode off-gas passage, a circulation passage connecting the anode gas passage and the anode off-gas passage, and the like. The fuel gas system may include a relief valve, a fuel gas supply pressure sensor, and an ejector in this order upstream of the fuel cell (anode gas passage), a first fuel supplier of an outer valve opening type and a second fuel supplier of an inner valve opening type may be disposed downstream of the relief valve and upstream of the ejector, a gas-liquid separator and an exhaust water valve may be disposed downstream of the fuel cell (anode off-gas passage), the ejector and the gas-liquid separator may be connected by a circulation passage, and the fuel gas may be circulated in the fuel gas system. The fuel gas supply pressure sensor may be provided upstream of the first fuel supplier of the external valve opening type and the second fuel supplier of the internal valve opening type. The outer-valve-open first fuel supplier and the inner-valve-open second fuel supplier may be arranged in parallel. The fuel cell system of the present disclosure includes a fuel gas system, and usually includes an oxidant gas system and a cooling system. The fuel gas system supplies fuel gas to at least the anode of the fuel cell, and circulates fuel off-gas (anode off-gas), which is the reacted fuel gas discharged from the anode of the fuel cell, in the fuel gas system, or discharges the fuel off-gas to the outside of the fuel gas system as necessary. The oxidant gas system supplies the oxidant gas to at least the cathode of the fuel cell, and discharges the oxidant off-gas (cathode off-gas), which is the reacted oxidant gas discharged from the cathode of the fuel cell, to the outside of the oxidant gas system as necessary. The cooling system supplies a cooling medium to at least the fuel cell, circulates the cooling medium inside and outside the fuel cell as necessary, and adjusts the temperature of the fuel cell. The fuel off-gas may include the fuel gas that has passed unreacted at the anode and the moisture generated at the cathode that has reached the anode. The fuel off-gas may include a corrosive substance generated in the catalyst layer, the electrolyte membrane, and the like, and an oxidant gas that may be supplied to the anode during scavenging.

The first fuel supplier of the external valve opening type may be, for example, a linear solenoid valve. Since the fuel gas supply pressure acts in the valve opening direction, the external valve can be opened with a small electromagnetic force when the fuel gas supply pressure is excessively large. Examples of the second fuel supplier of the internal valve opening type include an injector and the like. Since the fuel gas supply pressure acts in the valve closing direction, the inner opening valve is less likely to be opened when the fuel gas supply pressure is excessively high.

As the fuel gas supply pressure sensor, a conventionally known pressure gauge or the like can be used. The fuel gas supply pressure sensor may be disposed in the fuel gas system upstream of the externally-opened first fuel supplier or upstream of the internally-opened second fuel supplier. The fuel gas supply pressure sensor detects a fuel gas supply pressure in the fuel gas system. The fuel gas supply pressure sensor may be electrically connected to the control unit. The control unit detects the pressure acquired by the fuel gas supply pressure sensor.

The relief valve is a mechanism for discharging gas such as fuel gas to the atmosphere when the primary pressure becomes excessive due to permeation of the fuel gas from the pressure reducing valve or the like. Normally, the valve opening pressure of the relief valve is set higher than the normal primary pressure in order to prevent the gas from being inadvertently opened to the atmosphere.

The fuel cell system of the present disclosure may include a control unit. The control unit physically includes, for example, an arithmetic processing unit such as a central processing unit (CPU), a read-only memory (ROM) that stores control programs processed by CPU, control data, and the like, a storage device such as a random access memory (RAM) that is mainly used as various working areas for the control processing, and an input/output interface. The control unit may be, for example, a control device such as an electronic control unit Electronic Control Unit (ECU). The control unit may be electrically connected to an ignition switch that may be mounted on a moving body such as a vehicle. The control unit may be operable by an external power source even when the ignition switch is turned off.

The fuel cell system of the present disclosure may include a fuel cell. The fuel cell may have only one single cell, or may be a fuel cell stack that is a stacked body in which a plurality of single cells is stacked. In the present disclosure, both the single cell and the fuel cell stack may be referred to as a fuel cell. The number of stacked single cells is not particularly limited, and may be, for example, 2 to several hundred.

The single cell of the fuel cell includes at least a membrane electrode gas diffusion layer assembly. The membrane electrode gas diffusion layer assembly includes an anode-side gas diffusion layer, an anode catalyst layer, an electrolyte membrane, a cathode catalyst layer, and a cathode-side gas diffusion layer in this order.

The cathode (oxidant electrode) includes a cathode catalyst layer and a cathode-side gas diffusion layer. The anode (fuel electrode) includes an anode catalyst layer and an anode-side gas diffusion layer. The cathode catalyst layer and the anode catalyst layer are collectively referred to as catalyst layers. Examples of the anode catalyst and the cathode catalyst include Pt (platinum), Ru (ruthenium), and the like, and examples of the support on which the catalyst is supported include carbon materials such as carbon.

The cathode-side gas diffusion layer and the anode-side gas diffusion layer are collectively referred to as gas diffusion layers. The gas diffusion layer may be an electroconductive member or the like having gas permeability. Examples of the electroconductive member include porous carbon bodies such as carbon cloth and carbon paper, and porous metal bodies such as metal mesh and metal foam.

The electrolyte membrane may be a solid polymer electrolyte membrane. Examples of solid polymer electrolyte membranes include fluorine-based electrolyte membranes such as perfluorosulfonic acid thin films containing moisture, and hydrocarbon-based electrolyte membranes. As the electrolyte membrane, for example, a Nafion membrane (manufactured by DuPont) may be used.

The single cell may include two separators that sandwich both surfaces of the membrane electrode gas diffusion layer assembly as needed. The two separators are one anode-side separator and the other cathode-side separator. In the present disclosure, the anode-side separator and the cathode-side separator are collectively referred to as a separator. The separator may have holes constituting a manifold such as a supply hole and a discharge hole for allowing a fluid such as a reaction gas and a cooling medium to flow in the stacking direction of the single cells. As the cooling medium, for example, a mixed solution of ethylene glycol and water can be used in order to suppress freezing at low temperatures. Examples of the supply hole include a fuel gas supply hole, an oxidant gas supply hole, and a cooling medium supply hole. Examples of the discharge hole include a fuel gas discharge hole, an oxidant gas discharge hole, and a cooling medium discharge hole. The separator may have a reactant gas channel on the surface in contact with the gas diffusion layer. In addition, the separator may have a cooling medium flow path for keeping the temperature of the fuel cell constant on a surface opposite to the surface in contact with the gas diffusion layer. The separator may be a gas-impermeable electroconductive member or the like. The conductive member may be, for example, dense carbon obtained by compressing carbon to make it gas impermeable, a press-molded metal (for example, iron, aluminum, stainless steel, etc.) plate or the like. In addition, the separator may have a current collecting function.

The fuel cell stack may have a manifold such as an inlet manifold with which each supply hole is in communication and an outlet manifold with which each discharge hole is in communication. Inlet manifolds include anode inlet manifolds, cathode inlet manifolds, and cooling medium inlet manifolds. Outlet manifolds include anode outlet manifolds, cathode outlet manifolds, and cooling medium outlet manifolds.

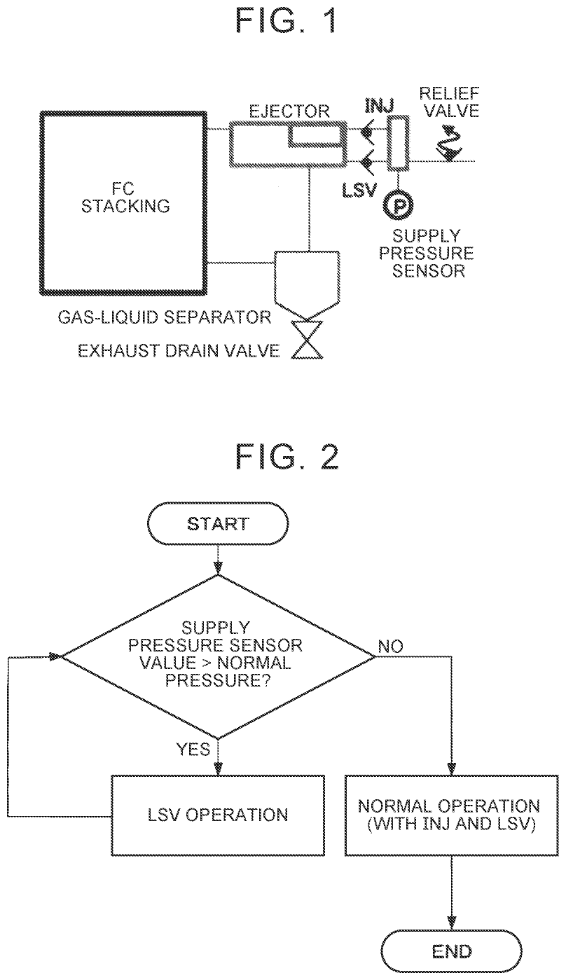

FIG. 1 is a schematic configuration diagram illustrating an example of a fuel cell system of the present disclosure. In the fuel cell system shown in FIG. 1, the description of the oxidant gas system and the cooling system is omitted for the sake of convenience. The fuel cell system shown in FIG. 1 includes a fuel cell (FC) stack and a fuel gas system. The fuel gas system has a relief valve and an ejector in this order in an upstream (anode gas passage) of the fuel cell, and an injector and a linear solenoid valve are arranged in parallel downstream of the relief valve and upstream of the ejector, and the fuel gas supply pressure sensor is arranged downstream of the relief valve and upstream of the injector and the linear solenoid valve, and has a gas-liquid separator and an exhaust-water valve in a downstream (anode off-gas passage) of the fuel cell, and an ejector and a gas-liquid separator are connected by a circulation passage, and a circulation system in which the fuel gas can be circulated in the fuel gas system is constructed.

An example of the control of the fuel cell system of the present disclosure is as follows. In the fuel cell system of the present disclosure, when the fuel gas supply pressure is excessive, the fuel cell is operated by a first fuel supplier (the valve opening at the time of high pressure is easy), and when the fuel gas supply pressure is normal, the fuel cell is operated by a combination of a first fuel supplier and a second fuel supplier. That is, when the fuel gas supply pressure sensor value exceeds the normal use pressure, the fuel cell system of the present disclosure drives the first fuel supplier (LSV) of the external valve opening type to operate FC. When the fuel gas supply pressure falls within the normal pressure range, a normal control is adopted in which the second fuel supplier (INJ) of the internal valve opening type and the first fuel supplier (LSV) of the external valve opening type are used together. Accordingly, since the second fuel supplier of the internal valve opening type does not need to be opened at the normal pressure or higher, it is possible to prevent the solenoid, which is a component of the second fuel supplier of the internal valve opening type, from becoming larger in size.

FIG. 2 is a flowchart illustrating an example of control of the fuel cell system of the present disclosure. The control unit determines whether or not the fuel gas supply pressure (supply pressure sensor value) measured by the fuel gas supply pressure sensor exceeds a predetermined threshold value (normal pressure). When the fuel gas supply pressure measured by the fuel gas supply pressure sensor exceeds a predetermined threshold value, the control unit determines that the fuel gas supply pressure is excessive, and operates the fuel cell by the first fuel supplier. When the fuel gas supply pressure measured by the fuel gas supply pressure sensor is equal to or lower than a predetermined threshold value, the control unit determines that the fuel gas supply pressure is normal, and operates the fuel cell using the first fuel supplier and the second fuel supplier in combination.

What is claimed is:

1. A fuel cell system comprising a first fuel supplier of an external valve opening type, a second fuel supplier of an internal valve opening type, and a fuel gas supply pressure sensor in a fuel gas system, wherein:
when a fuel gas supply pressure is excessively high, the first fuel supplier operates a fuel cell; and
when the fuel gas supply pressure is normal, the fuel cell is operated in combination of the first fuel supplier and the second fuel supplier.

2. The fuel cell system according to claim 1, wherein:
the first fuel supplier is a linear solenoid valve; and
the second fuel supplier is an injector.

3. The fuel cell system according to claim 1, further comprising a control unit, wherein:
the control unit determines whether the fuel gas supply pressure measured by the fuel gas supply pressure sensor exceeds a predetermined threshold value;
when the fuel gas supply pressure measured by the fuel gas supply pressure sensor exceeds the predetermined threshold value, the control unit determines that the fuel gas supply pressure is excessively high, and operates the fuel cell by the first fuel supplier; and
when the fuel gas supply pressure measured by the fuel gas supply pressure sensor is equal to or less than the predetermined threshold value, the control unit determines that the fuel gas supply pressure is normal, and operates the fuel cell in combination of the first fuel supplier and the second fuel supplier.
